(19) United States
(12) Patent Application Publication
(10) Pub. No.: US 2021/0201688 A1
(43) Pub. Date: Jul. 1, 2021

(54) Real Time Formative Assessment and Lesson Plan Recommendation With Remedial Learning Assessment

(71) Applicant: Pearson Education, Inc., New York, NY (US)

(72) Inventors: Varsha Agarwal, Bangalore, Karnataka (IN); Deepak Mehrotra, Bangalore, Karnataka (IN); Parimal Pereira, Salcete, Goa (IN); Gopinath Rangaswamy, Bangalore, Karnataka (IN); Ujjwal Singh, Bangalore, Karnataka (IN)

(21) Appl. No.: 16/071,626

(22) PCT Filed: Apr. 19, 2018
(86) PCT No.: PCT/US2018/028312

§ 371 Date: Jul. 20, 2018

Related U.S. Application Data
(60) Provisional application No. 62/584,397, filed on Nov. 10, 2017.
(60) Provisional application No. 62/568,100, filed on Oct. 4, 2017.

(51) Int. Cl. G09B 7/04

(52) U.S. Cl. CPC G09B 7/04

(57) ABSTRACT

A system may include one or more server hardware computing devices or client hardware computing devices, communicatively coupled to a network, and each comprising at least one processor executing specific computer-executable instructions within a memory. The instructions, when executed, may cause the system to: receive, with a client device, answers to a question from polling hardware possessed by students, store the answers in a non-volatile memory, analyze the answers to assess whether the individual answers are correct or incorrect and to identify one or more misconceptions associated with the incorrect answers, generate assessment data based on the analysis, determine changes that should be made to a lesson plan based on the assessment data, provide a client device with a prompt to make the determined changes to the lesson plan, and display one or more graphical representations of the assessment data on a display of the client device.

### CROSS REFERENCE TO RELATED APPLICATIONS

This application claims priority to U.S. Provisional Patent Application No. 62/568,100, filed on Oct. 4, 2017, and entitled “REAL TIME FORMATIVE AND LESSON PLAN RECOMMENDATION,” and U.S. Provisional Patent Application No. 62/584,397, filed on Nov. 10, 2017, and entitled “REAL TIME FORMATIVE ASSESSMENT AND LESSON PLAN RECOMMENDATION WITH REMEDIAL LEARNING ASSESSMENT,” the entire contents of which are incorporated herein by reference.

### FIELD OF THE INVENTION

This disclosure relates to the field of systems and methods configured to conduct entire-classroom formative assessments using polling techniques. Lesson plan recommendations are automatically generated based on the formative assessments.

### SUMMARY OF THE INVENTION

The present invention provides systems and methods comprising one or more server hardware computing devices or client hardware computing devices, communicatively coupled to a network, and each comprising at least one processor executing specific computer-executable instructions within a memory that, when executed, cause the system to: receive, with a client device, answers to a question from polling hardware possessed by students, store the answers in a non-volatile memory, analyze the answers to assess whether the individual answers are correct or incorrect and to identify one or more misconceptions associated with the incorrect answers, generate assessment data based on the analysis, determine changes that should be made to a lesson plan based on the assessment data, provide a client device with a prompt to make the determined changes to the lesson plan, and display one or more graphical representations of the assessment data on a display of the client device.

The received answers may correspond to a question posed to the students (e.g., written on a board, projected onto a screen or wall, written in a textbook, electronically transmitted to the students' polling hardware, etc.). The question may be related to a concept being taught to the students according to a lesson plan. The question may be presented with a finite number of answer choices with one of the answer choices being a correct answer choice and the remainder of the answer choices being incorrect answer choices. Each of the incorrect answer choices may be associated with one or more misconceptions regarding the concept. For example, a first incorrect answer choice may be associated with a first misconception and a second incorrect answer choice may be associated with a second misconception that is different from the first misconception. A remote server device may store predetermined misconception data indicative of the relationship (e.g., association) between each incorrect answer choice and its associated misconceptions in a non-transitory memory of the remote server device (e.g., as part of a look-up table (LUT)).

As an example, the polling hardware may include response cards upon which quick response (QR) codes are printed. Each QR code may be unique to a corresponding student, with no two students having the same QR code on their response cards. In this way, the QR code on a student's response card may be used to identify that student. Each student may hold up their response card in one of four orientations to indicate their selected answer. In the present example, the client device used to receive the answers may include a camera that is used to capture an image containing all of the QR codes on the response cards being held up by the students. The amount of time required to capture all of the QR codes may increase as the number of QR codes needing to be captured increases. The captured image may be analyzed, either at the client device or at the remote server device, to extract the answer and student information represented by each QR code contained within the image. This example is meant to be illustrative and not limiting. If desired any other polling methods and corresponding polling hardware may be used, including classroom response system (CRS) electronic devices, applications running on mobile devices (e.g., smartphones), or color coded response cards.

The answers received from the polling hardware may be stored on a non-transitory memory of the client device (e.g., a desktop personal computer or a mobile device). The client device may transfer the answers to the remote server device through a communications network (e.g., the internet, a local area network, or a wide area network), where the answers are then stored on the non-transitory memory of the remote server device. The remote server device may analyze the stored answers to determine the number of answers corresponding to each possible answer choice, to identify, for each answer of the stored answers, whether that answer is a correct answer or an incorrect answer, to identify a most frequently selected incorrect answer choice from among the incorrect answers, and to identify misconceptions associated with the incorrect answers. The remote server device may generate assessment data that includes the results of this analysis.

When identifying the misconceptions associated with the incorrect answers, the remote server device may access the predetermined misconception data to identify a respective misconception that is associated with each incorrect answer choice represented in the incorrect answers. The remote server device may then determine how the lesson plan can be altered in order to correct these misconceptions regarding the concept, and the remote server device may provide a prompt at the client device requesting that these alterations be applied to the lesson plan.

The server may provide graphical representations of the assessment data to the client device. For example, a list of the students' names and/or identification numbers may be provided along with indicators of whether each student's respective answer was a correct answer or an incorrect answer. The graphical representations may also include charts or graphs showing the percentage of correct answers and the percentage of incorrect answers for the entire group of students. Additional graphical representations may be provided that display, for each of the possible answer choices, the number of answers corresponding to that answer choice. Identified misconceptions may also be graphically represented (e.g., via a pie chart or a bar chart) so that the most prevalent misconception or misconceptions can be visually discerned. The graphical representations may be stored in the non-transitory memory of the remote server device and may be accessible by multiple client devices. For example, parents, students, and teachers may be able to access remote server device to view the graphical representations of the assessment data for all of the students or for a single student, depending on the level of access available to the individual accessing the remote server device, through a web portal.

As another example, a server may receive multiple sets of answers to a question related to a topic, where the received answers respectively correspond to different classrooms of students, and where a different lesson plan is used to teach the topic in each classroom. A given lesson plan may be evaluated by determining a percentage of correct answers that were submitted by students taught using that lesson plan to the total number of answers submitted by the students taught using that lesson plan. This evaluation may be performed by a processor of the server for each lesson plan to determine scores for the lesson plans. The scores for the lesson plans may be compared against a baseline lesson plan (e.g., using the processor) to determine a weight to be assigned for each lesson plan. The lesson plan with the highest weight may be recommended to teachers who intend to teach the topic.

As another example, a server may receive answers submitted by students in response to a question related to a topic that has been taught to the students using a lesson plan. A processor of the server may calculate a difficulty index for the question by comparing (e.g., dividing) the number of correct answers of the received answers to the total number of received answers. For a first answer of a first student, the processor may determine that the first answer is incorrect. The processor may then determine that the question is not difficult by determining that the difficulty index for the question is less than a baseline difficulty threshold. The processor may then increment a remediation score of the student. The processor may then determine that the student's remediation score is higher than a remediation threshold value. If the processor determines that the student is not already assigned a remediation course for the topic, the processor may then assign a remediation course for the topic to the student. Otherwise, if the processor determines that the student is already assigned a remediation course for the topic, the processor may then notify the student's teacher that the student needs instructional intervention.

For a second answer of a second student, the processor may determine that the second answer is incorrect. The processor may then determine that the question is difficult by determining that the difficulty index for the question is greater than a baseline difficulty threshold. The processor may then increment a difficulty store for the assessment or test being given to the students. If the processor determines that the difficulty score exceeds a predetermined threshold, the test or assessment may be flagged for difficulty and the students' teacher may be sent a notification (e.g., using the processor).

For a third answer of a third student, the processor may determine that the third answer is correct. The processor may then increment a progress score for the third student.

The above features and advantages of the present invention will be better understood from the following detailed description taken in conjunction with the accompanying drawings.

### BRIEF DESCRIPTION OF THE DRAWINGS

FIG. 1 illustrates a system level block diagram for a system that includes client devices used to interact with polling hardware and servers used to analyze answers collected from the polling hardware by the client devices.

FIG. 2 illustrates a system level block diagram for a computer system that may correspond to any of the individual computing devices or servers of the network 100 shown in FIG. 1.

FIG. 3 is a diagram of an illustrative process flow that may be performed by a client device during a functional assessment of a group of students in accordance with an embodiment.

FIG. 4 is a diagram of an illustrative process flow that may be performed by a remote server device during a functional assessment of a group of students in accordance with an embodiment.

FIG. 5 shows an illustrative diagram of an adaptive teaching architecture, in accordance with an embodiment.

FIG. 6 shows an illustrative diagram of a recursive adaptive teaching model that may be implemented in conjunction with the adaptive teaching architecture of FIG. 5, in accordance with an embodiment.

FIG. 7 shows an illustrative process flow that may be performed by a remedial learning engine in conjunction with the adaptive teaching architecture of FIG. 5, in accordance with an embodiment.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

### Network

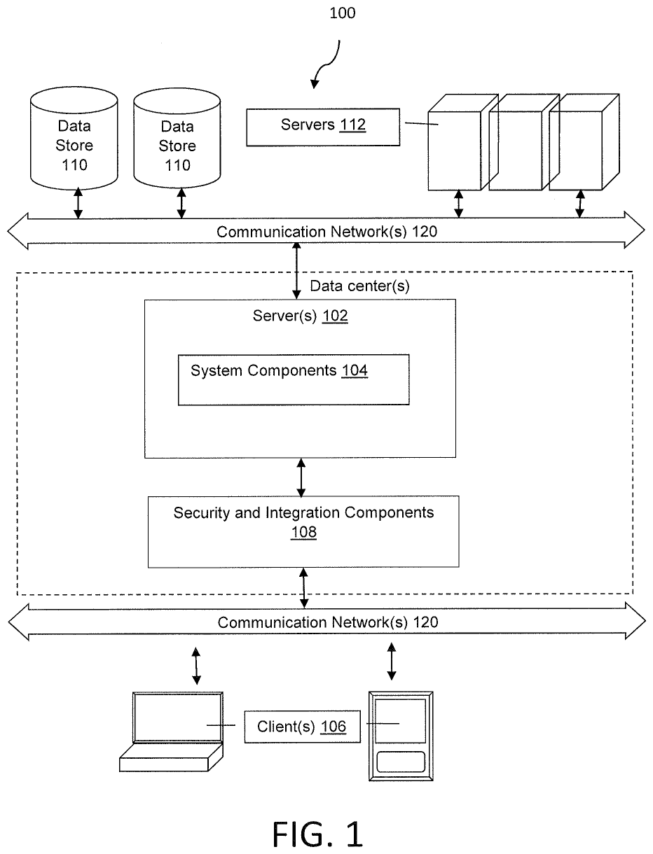

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

### Servers/Clients

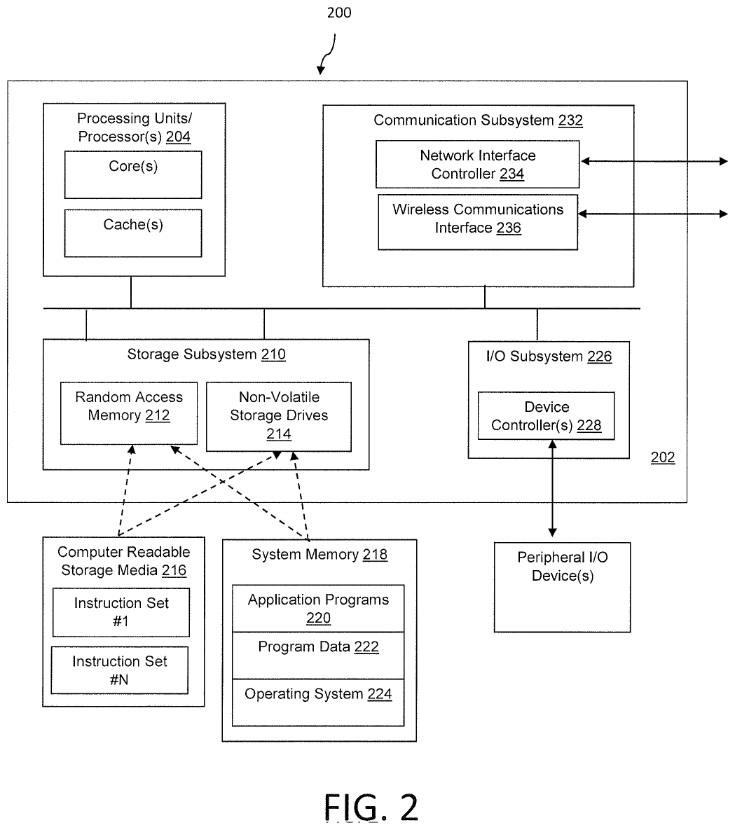

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

### Security

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

### Data Stores (Databases)

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

### Computer System

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

### Processors

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

### Buses

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

### Input/Output

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

### Input

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

### Output

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

### Memory or Storage Media

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

### Computer Readable Storage Media

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

### Communication Interface

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

### Input Output Streams Etc.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

### Connect Components to System

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

### Other Variations

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

### Formative Assessment—Introduction

Formative assessment is defined herein as a range of formal and informal assessment procedures conducted during the learning process in order to modify teaching and learning activities. After students (e.g., in a classroom) perform an activity through which the students learn about a concept/topic, the students' understanding of the concept/topic is verified by presenting the students with a question related to the concept/topic. The students' answers to this question are then analyzed to determine a percentage of the students that answered the question correctly and a percentage of the students that answered the question incorrectly. The results of this analysis are provided to the teacher to provide quantitative feedback regarding the students' understanding of the concept/topic. The incorrect answers provided by the students may be further analyzed to identify one or more common misconceptions held by the majority of the students that answered the question incorrectly. The teacher may then be provided with a prompt indicating that a lesson plan being used as a basis for teaching the students can be altered in order to correct the identified misconceptions of the concept/topic.

### Formative Assessment—Client Device

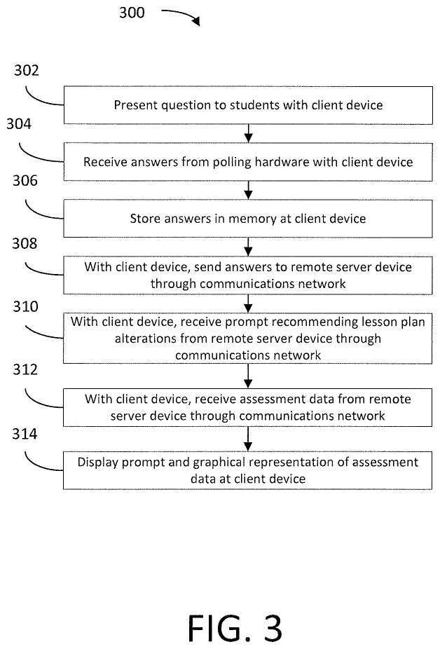

FIG. 3 shows an illustrative flowchart of a method 300 by which a client device (e.g., client 106 of FIG. 1) may perform a formative assessment of students' understanding of a concept. Method 300 may be performed after the students have participated in an activity intended to teach the students a concept (e.g., as part of a lesson plan or learning path).

At step 302, the client device may present a question to the students. For example, the client device may transmit the question to electronic devices (e.g., classroom response system (CRS) electronic devices or mobile devices) possessed by the students. As another example, the client device may display the question on a screen or surface visible to the students (e.g., using a projector coupled to the client device). The question may be presented along with a finite number of answer choices from which the students may select their answer. Optionally, the question and answer choices may be presented to the students through a textbook or the teacher may write the question and answer choices on a surface that is visible to the students (e.g., a whiteboard or a chalk board).

At step 304, the client device receives answers from polling hardware possessed by the students. For example, the students may submit their answers to the question by pressing buttons on electronic devices (e.g., classroom response system (CRS) electronic devices or mobile devices). These electronic devices may then transmit the submitted answers to the client device. As another example, the students may possess response cards, upon which are printed quick response (QR) codes or other predefined patterns (e.g., color coded patterns). For instances in which QR code response cards are used, each student may have a single respective response card, and the student's answer to the question may be indicated by the angle at which the response card is positioned when the student holds up the response card. A given student may have a QR code on their response card that is unique (e.g., unique within the group of students being assessed) to that student so that no two QR codes on any two response cards are the same. Answers submitted by holding up response cards may be captured using an imaging system (e.g., camera) at the client device. This imaging system may identify response card locations and may capture images of multiple response cards simultaneously. The amount of time required to identify and capture images of multiple response cards may increase as the number of response cards to be captured increases.

At step 306, the received answers are stored in a non-transitory memory (e.g., data stores 110 of FIG. 1 or computer-readable storage media 216 of FIG. 2) of the client device. Student identification data that identifies the student that submitted a given received answer may also be stored in the memory for each of the received answers. For instances in which QR code response cards are used to submit the answers, the captured images of the QR code response cards may first be translated into answers and student identification data, and these answers and student identification data may then be stored in the memory. Alternatively, the captured images of the QR code response cards may be stored in the memory, and may not be translated into answers and student identification data until they are sent to a remote server device (described below). If the client device does not have immediate access to the communication network, the client device may retain the stored answers until access to the communication network is re-established, at which time the client device will proceed to step 308.

At 308, the client device sends the stored answers and corresponding student identification data to a remote server device (e.g., servers 112) through a communications network (e.g., communication network 120 of FIG. 1) using a communications subsystem (e.g., communications subsystem 232 of FIG. 2).

At 310, the client device receives a prompt recommending lesson plan alterations from the remote server device through the communications network. The prompt may recommend one or more activities that may be performed in order to address identified misconceptions associated with the incorrect answers submitted by the students. The teacher may choose to accept the recommendation provided by the prompt and may perform the recommended activities, thus altering the lesson plan. The teacher may alternatively choose to not follow the recommendation and may instead proceed without altering the lesson plan.

At 312, the client device receives assessment data from the remote server device through the communications network. The assessment data may include analytical data corresponding to the stored answers that were sent to the remote server device. For example, the assessment data may define the number of incorrect answers of the stored answers, the number of correct answers of the stored answers, a percentage of the stored answers that are incorrect answers, a percentage of the stored answers that are correct answers, the respective number of times each possible answer choice was selected by the students, a respective percentage of the stored answers corresponding to each possible answer choice, misconceptions corresponding to the incorrect answer choices, and respective percentages of the stored answers corresponding to each misconception. The assessment data may also include historical assessment data corresponding to groups of answers to previously assessed questions.

At 314, the client device may display some or all of the assessment data through graphical representations (e.g., charts and graphs) via an electronic display at or coupled to the client device. For example, a pie chart depicting the ratio of correct answers to incorrect answers may be displayed. A bar graph depicting the number of respective answers corresponding to each possible answer choice may be displayed. A list of the students may be displayed, where each student's identification (e.g., name, ID number, etc.) is displayed alongside that student's selected answer along with an indicator of whether that student's selected answer is correct or incorrect. A pie chart and/or a bar graph depicting the distribution of the answer choices that were selected by the students may be displayed. A pie chart and/or bar graph depicting the distribution of the misconceptions associated with the answer choices that were selected by the students may be displayed. The above graphs and charts may be accessed through a user-interface displayed on the electronic display at or connected to the client device.

### Formative Assessment—Remote Server Device

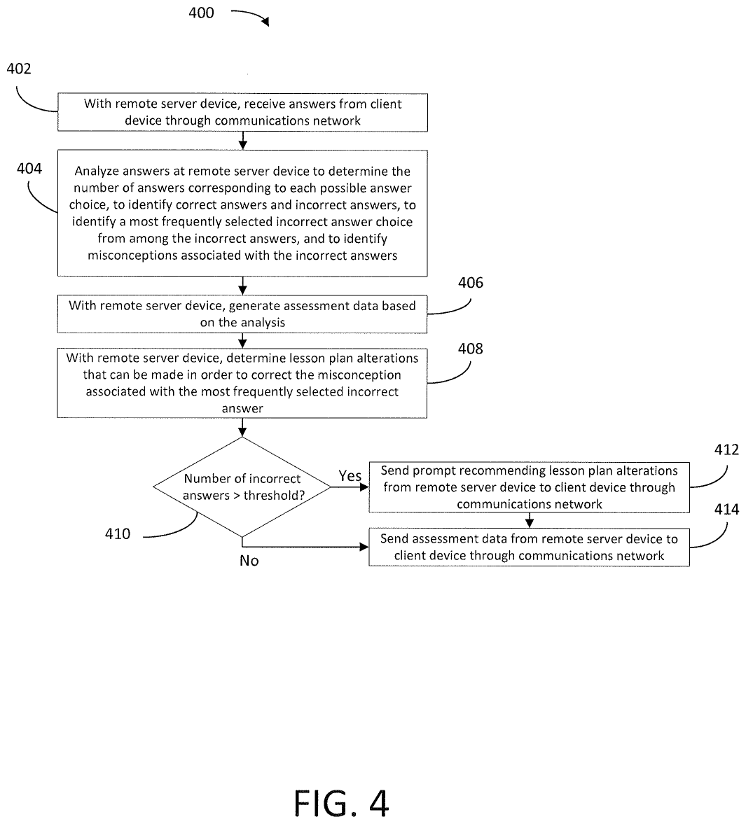

FIG. 4 shows an illustrative flowchart of a method 400 by which a remote server device (e.g., server 112 of FIG. 1) may collect and analyze data generated during a formative assessment of students' understanding of a concept. Method 400 may be performed after the students' have been received and stored at a client device (e.g., according to steps 302-306 of method 300 shown in FIG. 3).

At 402, the remote server device receives answers from the client device through the communications network. These answers may be stored in a non-transitory memory of the remote server device (e.g., in storage subsystem 210 shown in FIG. 2).

At 404, the remote server device analyzes the answers. In performing this analysis, the remote server device may determine the number of answers corresponding to each respective possible answer choice. For example, if the students were given options A, B, C, and D as possible answer choices for responding to the question, the remote server device may determine the number of answers corresponding to option A, the number of answers corresponding to option B, the number of answers corresponding to option C, and the number of answers corresponding to option D.

The remote server device may further identify how many of the answers are correct answers and how many of the answers are incorrect answers. Returning the above example, assuming option A is the correct answer, while options B, C, and D are incorrect answers, the remote server device may identify option A as the correct answer and may identify options B, C, D as the incorrect answers (e.g., by accessing a look up table (LUT) that stores information regarding which of the possible answer choices is correct and which are incorrect). The remote server device then determines that the answers corresponding to option A are correct answers, that the number of answers corresponding to option A is the number of correct answers, that the answers corresponding to options B, C, and D are incorrect answers, and that the number of answers corresponding to options B, C, and D, is the number of incorrect answers.

The remote server may further identify a most frequently selected incorrect answer choice from among the incorrect answers. Returning to the above example, if the number of answers corresponding to option B exceeds the number of answers corresponding to option C and exceeds the number of answers corresponding to option D, the remote server device may identify option B as the most frequently selected incorrect answer choice.

The remote server may further identify misconceptions associated with the incorrect answers. Returning to the above example, option B may correspond to a spelling error, option C may correspond to a conceptual error, and option D may correspond to a grammatical error. Here, the spelling error, the conceptual error, and the grammatical error are considered to be respective misconceptions. A LUT in the non-transitory memory of the remote server device may store relationships between each incorrect answer choice and a respective corresponding misconception related to that incorrect answer choice. The remote server device may access the LUT in order to identify these misconceptions and the incorrect answer choices to which they correspond. The remote server device may thereby determine that option B corresponds to a spelling error, option C corresponds to a conceptual error, and option D corresponds to a grammatical error. It should be understood that the above misconceptions are illustrative and any desired variety of misconceptions may be tagged to the incorrect answer choices.

At 406, the remote server device generates assessment data based on the analysis of the answers. The assessment data may include the results of the analyses performed in connection with step 404, described above. In some instances, the assessment data may include graphical representations of the results of the analyses (e.g., as described in detail in connection with step 314 of FIG. 3).

At 408, the remote server device determines possible lesson plan alterations that can be made in order to correct a misconception associated with a most frequently selected incorrect answer choice (e.g., a modal incorrect answer choice that is modal to the set of incorrect answers). For example, if the most frequently selected incorrect answer choice is associated with a computational error, the remote server device may determine that the lesson plan could be altered to assign worksheets to the students so that the students may be provided with more practice performing computations related to the computational error. As another example, for a conceptual error, the remote server device may determine that the lesson plan could be altered to provide an additional lecture or worksheet re-explaining the concept to the students. As another example, for an application error, the remote server device may determine that the lesson plan could be altered to show a video to the students or to have the students play a game in order to either show the students how the concept can be applied or to give the students an opportunity to apply the concept themselves.

At 410, the remote server device determines whether the number of incorrect answers submitted by the students exceeds a predetermined threshold. If the predetermined threshold is exceeded, method 400 may proceed to step 412. Otherwise if the predetermined threshold is not exceeded, method 400 may skip step 412 and proceed directly to step 414.

At 412, the remote server device sends a prompt recommending the lesson plan alterations (determined in step 408) to the client device through the communications network.

At 414, the remote server device sends the assessment data to the client device through the communications network. This assessment data may be sent to the client device in response to a request received from the client device. This assessment data may be accessible from the remote server device to other client devices as well, for example, via a communication network such as the internet.

### Formative Assessment—Adaptive Teaching Architecture

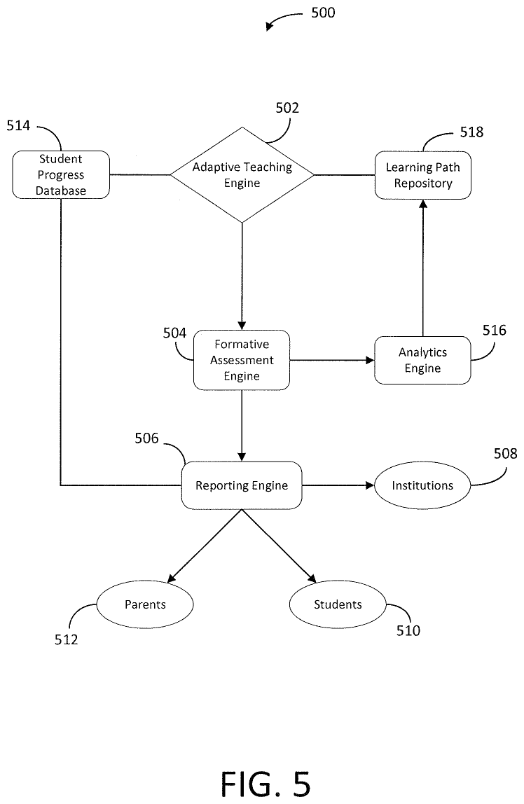

FIG. 5 shows an illustrative diagram of an adaptive teaching architecture that may implement the formative assessment described above in connection with FIGS. 3 and 4.

As shown, adaptive teaching architecture 500 includes an adaptive teaching engine 502, a formative assessment engine 504, a reporting engine 506, a student progress database 514, an analytics engine 516, and a learning path repository 518. Adaptive teaching architecture 500 may, for example, be implemented on a server (e.g., server 112 of FIG. 1), which may be used in the performance of a formative assessment of one or more groups of students (e.g., according to method 400 of FIG. 4).

Adaptive teaching engine 502 may, for example, be a process executed on one or more processors of the server (e.g., server 112 of FIG. 1). Adaptive teaching engine 502 may interface (e.g., through communication network 120 of FIG. 1) between the client device (e.g., client device 106 of FIG. 1) being used by a teacher, and the formative assessment engine 504, the student progress database 514, and the learning path repository 518.

Formative assessment engine 504 may receive the results of formative assessments (e.g., according to the method 300 of FIG. 3) performed by a teacher using a client device (e.g., client device 106 of FIG. 1). These results may be provided to analytics engine 516, which may analyze the effectiveness of the lesson plan that was used to teach the topic/concept(s) being assessed in the formative assessment and/or the teacher who implemented the lesson plan. The results of this analysis may be provided to learning path repository 518, which may be used to determine an optimized learning path for the teacher or for any teacher wishing to teach the topics/concepts being assessed, which may then be recommended through adaptive teaching engine 502.

Learning path repository 518 may store multiple learning paths (e.g., in a non-transitory computer readable medium, such as in data stores 110 of FIG. 1 or computer-readable storage media 216 of FIG. 2) that may be used in implementing lesson plans for the teaching of various topics and concepts. The learning path for a given concept may, for example, include one or more activities that may be used to teach the given concept. For instances in which the learning path for the given concept includes multiple activities, these activities may be assigned a predetermined order in which the activities should be performed. When a teacher has indicated (e.g., at the client device) that they intend to teach a given concept (e.g., by requesting a learning path for the given concept), adaptive teaching engine 502 may access learning path repository 518 to retrieve a learning path that is recommended to be used when teaching the given concept, and may then provide a teacher with the learning path. Analytics engine 516 may alter a given learning path in learning path repository 518 based analysis performed by analytics engine 516 on the results of a formative assessment provided by formative assessment engine 504. For example, a learning path may be altered by removing activities from the learning path, adding activities to the learning path, or changing the order in which activities in the learning path are recommended to be performed.

Formative assessment engine 504 may also provide the results of formative assessments to reporting engine 506. Reporting engine 506 may analyze the results of a given formative assessment and may generate assessment data (e.g., generated at step 406 of method 400 of FIG. 4) based on this analysis. The generated assessment data may include: a percentage of incorrect answers submitted during the assessment, a percentage of correct answers submitted during the assessment, a percentage or ratio of the number of incorrect answers to the number of correct answers, respective percentages of submitted answers corresponding to each of the available answer choices provided during the assessment, the number of submitted answers corresponding to each available answer choice, misconceptions corresponding to each of the incorrect answer choices, and respective percentages of the incorrect answers corresponding to each misconception. This assessment data may be generated at the class level and/or at the individual student level.

Assessment data generated by reporting engine 506 may be accessed (e.g., via an electronic device connected to the remote server device through a communications network such as communications network 120 of FIG. 1) by institutions 508, students 510, and/or parents 512. When accessed, the assessment data may be presented (e.g., at a user interface shown on a display of the electronic device used by the institutions 508, the students 510, and/or the parents 512) using charts, graphs, tables, and/or any other appropriate graphical representation of data. The assessment data may be provided from reporting engine 506 to student progress database 514 (e.g., stored in a non-transitory computer readable medium, such as data stores 110 of FIG. 1 or computer-readable storage media 216 of FIG. 2), which may store the assessment data for each individual student and class of students (e.g., as historical assessment data).

### Formative Assessment—Adaptive Teaching Model

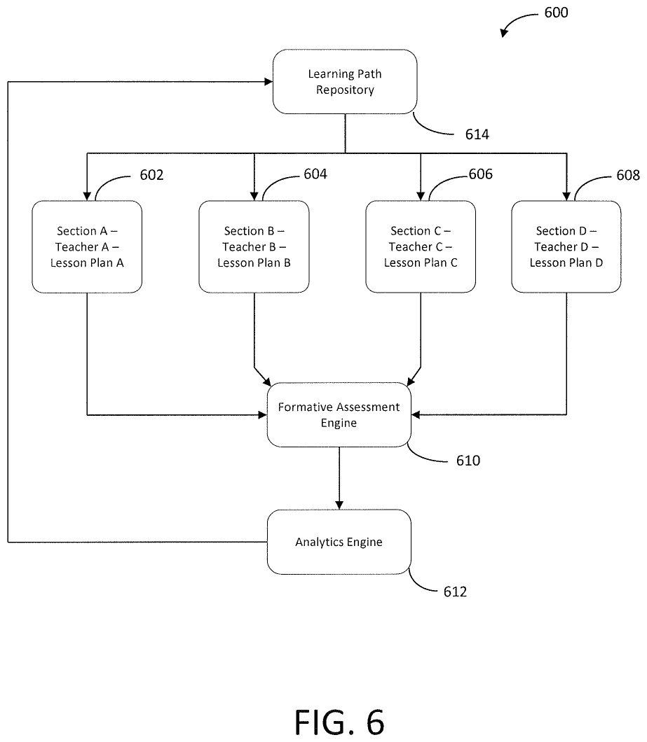

FIG. 6 shows an illustrative diagram of a recursive adaptive teaching model that may be implemented in conjunction with the adaptive teaching architecture 500 of FIG. 5.

As shown, adaptive teaching model 600 includes four classrooms, 602, 604, 606, 608, each having its own respective section identifier, teacher, and lesson plan. It should be noted that, while only four classrooms are shown here, any number of classrooms could be used in implementing adaptive teaching model 600. During the initial use of adaptive teaching model 600 (e.g., and adaptive teaching architecture 500 of FIG. 5) teachers A, B, C, and D each choose their own respective lesson plans A, B, C, and D for teaching a concept. Each of lesson plans A, B, C, and D may include one or more formative assessments (e.g., corresponding to some or all of method 300 of FIG. 3). As the formative assessments of lesson plans A, B, C, and D are performed, results of the formative assessments are provided to formative assessment engine 610 (e.g., formative assessment engine 504 of FIG. 5).

Formative assessment engine 610 may provide the results of the formative assessments from each of classrooms 602, 604, 606, and 608 to analytics engine 612 (e.g., analytics engine 516 of FIG. 5). Analytics engine 612 may analyze the effectiveness of each of lesson plans A, B, C, and D, as well as the effectiveness of each of teachers A, B, C, and D based on the results of the formative assessments. For example, analytics engine 612 may assign weights to individual components lesson plans (e.g., activities) of lesson plans A, B, C, and D, according to the effectiveness of those lesson plans. Each of teachers A, B, C, and D may similarly be assigned weights according to the effectiveness of those teachers. Lesson plan and teacher effectiveness may, for example, be determined by the number of correct responses to questions that were submitted during each formative assessment. The assigned weights may, for example, be a number between 0 and 1 and may be provided to learning path repository 614 (e.g., learning path repository 518 of FIG. 5).

As another example, class performance and other criteria may be assessed for each of lesson plans A, B, C, and D. In the present example, lesson plans A, B, and C may be lesson plans designed by teachers, while lesson plan D may be a baseline lesson plan that is provided as a preset, for example, as part of learning path repository 614.

TABLE 1
Lesson Plan Scoring

| | | Lesson Plan | Lesson Plan | Lesson Plan |
|---|---|---|---|---|
| Criteria | Baseline | A | B | C |
| Class | 70 | 60 | 75 | 70 |
| Performance | | | | |
| Additional | 60 | 80 | 55 | 70 |
| Criteria A | | | | |
| (optional) | | | | |
| Additional | 80 | 80 | 70 | 85 |
| Criteria B | | | | |
| (optional) | | | | |
| Total Score | 210 | 220 | 200 | 225 |

As shown in Table 1, each lesson plan may be scored according to class performance (e.g., a ratio or percentage of correct answers to total answers across all questions provided during the formative assessment for each respective lesson plan), as well as multiple additional criteria. For example, additional criteria A may be scored according the class performance for only a subset of the questions related to one or more core concepts of the topic being taught in the lesson plans. As another example, additional criteria B may be scored based on how quickly correct answers were submitted by the students after the presentation of the question.

Any lesson plan with a total score less than that of the baseline lesson plan will not be assigned a weight, while any lesson plan with a total score higher than that of the baseline lesson plan will be assigned a weight equal to the difference between the total score of the higher-scoring lesson plan and the baseline lesson plan. For example, in Table 1, lesson plan A would receive a weight of 10, lesson plan B would not receive a weight, and lesson plan C would receive a weight of 25. As lesson plan C would then have the highest weight, learning path repository 614 would recommend lesson plan C to teachers for the next time the assessed topic is to be taught.

It should be noted that the total score determined for each lesson plan may be a running average of historical scores of those lesson plans (e.g., for instances in which those lesson plans are used and assessed more than once).

Once weights have been assigned, analytics engine 612 may access learning path repository 614 and may select a learning path as the recommended learning path from the learning paths that are stored in learning path repository 614 and that is associated with teaching the concept. This selection of the recommended learning path may be performed according to the weights assigned to lesson plans A, B, C, and/or D and to teachers A, B, C, and/or D by analytics engine 612. For example, learning path repository 614 may determine an optimized learning path for use in teaching a concept using a neural network, where connections between nodes of the neural network are weighted according to the weights determined by analytics engine 516 when assessing the effectiveness of lesson plans A, B, C, and D and to teachers A, B, C, and D. As another example, the learning path recommended by learning path repository 614 may be the learning path corresponding to the lesson plan with the highest assigned weight (e.g., corresponding to the most effective lesson plan). As yet another example, the recommended learning path may be the learning path corresponding to the highest combination of assigned weight of the teacher and assigned weight of the lesson plan corresponding to that teacher. Learning path repository 614 may then provide the altered learning paths to teachers A, B, C, and D so that teachers A, B, C, and D may update lesson plans A, B, C, and D (if desired) to include the altered learning path. In this way, learning path recommendations provided by learning path repository 614 for a given concept may be optimized based on the observed effectiveness of different learning paths used in different lesson plans by different teachers in different classrooms to teach the given concept.

### Formative Assessment—Remedial Learning Engine

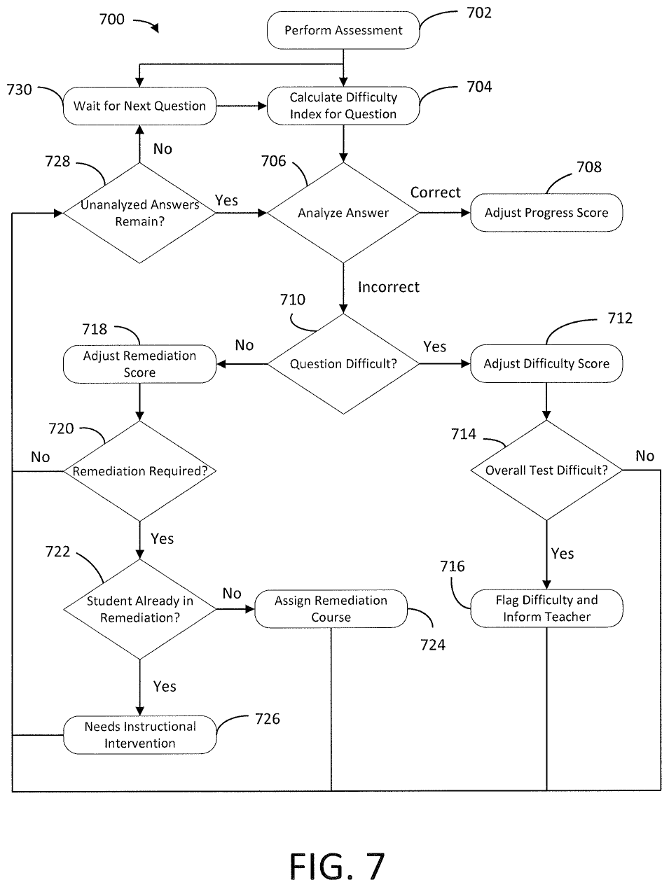

A remedial learning engine may be included as part of analytics engine 516, 612 of FIGS. 5 and 6, which may assess question difficulty, student progress, student need for remediation, and overall test/assessment difficulty, among other factors. An illustrative method 700 that can be performed by such a remedial learning engine is shown in FIG. 7. Method 700 may, for example, be performed by executing instructions (e.g., stored in memory 218 and/or computer-readable storage media 216, FIG. 2) using a hardware processor (e.g., processing units 204, FIG. 2).

At step 702, a formative assessment is performed by the processor (e.g., by formative assessment engine 504, 610 of FIGS. 4 and 5) in which a question is posed to a classroom of students, and student answers are collected and sent to an analytics engine (e.g., analytics engine 516, 612 of FIGS. 5 and 6) for analysis.

At step 704, all of the student answers collected during the formative assessment are assessed by the processor to determine the number of correct answers, and a difficulty index is calculated for the question based on the determined number of correct answers. For example, the difficulty index may be represented as the number of correct answers divided by the total number of student answers.

At step 706, an iterative sub-process begins in which each student's answer to the question is analyzed by the processor, until all of the student answers have undergone analysis. A given student answer is analyzed to determine if the given student answer is a correct answer or an incorrect answer. If the given student answer is determined to be correct, method 700 proceeds to step 708. Otherwise, if the given student answer is determined to be incorrect, method 700 proceeds to step 710.

At step 708, if the given student answer is determined by the processor to be correct, a progress score associated with the given student is adjusted. For example, if the question is related to the topic of addition and the given student answer is determined to be correct, the given student's progress score for the topic of addition may be incremented by one. Also, optionally, the student's remediation score may be decremented by one at this step and/or the test's/assessment's difficulty score may be decremented at this step.

At step 710, it is determined by the processor whether the question is difficult. For example, a predetermined baseline difficulty threshold may be assigned to the question (e.g., when the question is created, or by the teacher) and stored in memory. The predetermined baseline difficulty threshold may represent the number of students that are expected to be able to correctly answer the question. If the difficulty index determined at step 704 exceeds the predetermined baseline difficulty threshold, the question is determined to be difficult, and method 700 proceeds to step 712. Otherwise, if the difficulty index determined at step 704 does not exceed the predetermined baseline difficulty threshold, the question is determined to not be difficult, and method 700 proceeds to step 718.

At step 712, in response to the processor determining that the question is difficult and that the given student has answered the question incorrectly, a difficulty score for the test is incremented by one by the processor.

At step 714, the adjusted difficulty score is compared to a predetermined threshold by the processor. If the adjusted difficulty score exceeds the predetermined threshold, the overall assessment/test being performed may be flagged as difficult (e.g., for the particular group of students being assessed), and method 700 proceeds to step 716. Otherwise, if the overall assessment/test being performed is not determined to be difficult, method 700 proceeds to step 728.

At step 716, in response to determining that the overall assessment/text is difficult, a notification may be provided to the teacher by the processor. For example, the notification may advise the teacher to either teach the topic again to ensure the students can overcome difficult questions, or re-test the students using another assessment.

Turning now to step 718, when it is determined by the processor that the question is not difficult (e.g., that the difficulty index does not exceed the predetermined baseline difficulty threshold), a remediation score for the given student is adjusted by the processor. For example, the given student's remediation score may be incremented by one, so as to indicate that the given student may be in need of remediation as a result of the given student providing an incorrect answer to a question that has been determined to not be difficult. Also, optionally, the student's progress score may be decremented at this step.

At step 720 it is determined by the processor whether remediation is required for the given student based on the adjusted remediation score. For example, the adjusted remediation score may be compared to a remediation threshold value, with remediation being required if the adjusted remediation score exceeds the remediation threshold value. If remediation is determined to be required for the given student, method 700 may proceed to step 722. Otherwise, if remediation is not determined to be required, method 700 may proceed to step 728.

At step 722, it is determined by the processor whether the given student is already in remediation. If the given student is already in remediation, method 700 may proceed to step 726. Otherwise, if the given student is not already in remediation, method 700 may proceed to step 724.

At step 724, in response to the processor determining that the given student requires remediation, and is not already in remediation, a remediation course is assigned to the given student by the processor.

At step 726, in response to the processor determining that the given student requires remediation, and is already in remediation, the given student is assigned instructional intervention by the processor and a notification is sent (e.g., via electronic communication) by the processor.

At step 728, it is determined by the processor whether any unanalyzed answers remain (e.g., whether any answers to the question collected during the formative assessment have yet to undergo the analysis of steps 706-728). If unanalyzed answers are still present, method 700 proceeds to step 706 to begin the analysis of one of the unanalyzed answers. Otherwise, if no unanalyzed answers are still present (e.g., all answers to the question collected during the formative assessment have been analyzed), method 700 proceeds to step 730.

At step 730, the analysis engine waits for answers to the next question of the formative assessment to be received. Once another question has been received, method 700 returns to step 704.

As shown, steps 704-730 may be performed iteratively until all questions of the assessment/test have been answered, and the answers thereof analyzed.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

1. A system comprising:
a client device configured to collect answers from a group of students; and
a remote server device configured to execute instructions for:
receiving the answers from the client device through a communication network;
analyzing the answers to generate assessment data;
generating a lesson plan recommendation based on the assessment data; and
providing the lesson plan recommendation to the client device through the communication network.

2. The system of claim 1, wherein the answers are submitted by the group of students in response to a question presented to the group of students, wherein the question is associated with a correct answer choice and multiple incorrect answer choices, wherein each of the answers are associated with either the correct answer choice or one of the incorrect answer choices, and wherein analyzing the answers to generate the assessment data includes:
identifying correct answers of the answers that are associated with the correct answer choice;
identifying incorrect answers of the answers that are associated with the incorrect answer choices;
determining a ratio of the correct answers to the incorrect answers;
determining a modal incorrect answer choice from the incorrect answers; and
identifying a misconception associated with the modal incorrect answer choice.

3. The system of claim 2, wherein generating the lesson plan recommendation based on the assessment data comprises:
determining that the quantity of the incorrect answers exceeds a predetermined threshold; and
generating the lesson plan recommendation based on the identified misconception.

4. The system of claim 1, wherein the assessment data is accessible via a web portal.

5. The system of claim 1, wherein the client device is configured to collect answers from a group of students by capturing an image of the group of students and detecting quick response (QR) codes that are present within the captured image.

6. The system of claim 5, wherein a given QR code of the QR codes identifies a student of the group of students.

7. The system of claim 6, wherein an orientation of a given QR code of the QR codes corresponds to an answer submitted by the student.

8. A method comprising:
receiving, with a server device, first answers having a first quantity from a first client device, and second answers having a second quantity from a second client device;
analyzing, with a processor of the server device, the first answers and the second answers to generate first assessment data and second assessment data, respectively;
generating, with the processor, a lesson plan recommendation based on the first assessment data and the second assessment data; and
providing, with the processor, the lesson plan recommendation to the first and second client devices through a communication network.

9. The method of claim 8, wherein the first answers are submitted by first students taught using a first lesson plan, wherein the second answers are submitted by second students taught using a second lesson plan, and wherein the first answers and the second answers to generate the first assessment data and the second assessment data comprises:
determining, with the processor, a first percentage of first correct answers of the first answers;
assigning, with the processor, a first score to the first lesson plan based on the first percentage;
determining, with the processor, as second percentage of second correct answers of the second answers; and
assigning, with the processor, a second score to the second lesson plan based on the second percentage.

10. The method of claim 9, wherein generating the lesson plan recommendation based on the first assessment data and the second assessment data comprises:
comparing, with the processor, the first score of the first lesson plan to a third score of a baseline lesson plan to determine a first weight for the first lesson plan;
comparing, with the processor, the second score of the second lesson plan to the third score of the baseline lesson plan to determine a second weight for the second lesson plan;
determining, with the processor, that the first weight is greater than the second weight; and
generating, with the processor, the lesson plan recommendation by recommending the first lesson plan.

11. A method comprising:
receiving, at a server device, answers provided by students in response to a question corresponding to a topic;
analyzing, with a processor of the server device, a first answer of the answers provided by a first student of the students;
determining, with the processor, that the first student requires remediation; and
assigning, with the processor, a remediation course to the first student.

12. The method of claim 11, further comprising:
calculating, with the processor, a difficulty index for the question by dividing a total number of correct answers of the answers by a total number of the answers.

13. The method of claim 12, wherein determining that the first student requires remediation comprises:
determining, with the processor, that the first answer is incorrect;
determining, with the processor, that the difficulty index is less than a baseline difficulty threshold;
incrementing, with the processor, a first remediation score associated with the first student;
determining that the first remediation score exceeds a remediation threshold value; and
determining, with the processor, that the first student has not already been assigned any remediation course for a topic related to the question.

14. The method of claim 12, further comprising:
analyzing, with the processor, a second answer of the answers provided by a second student of the students;
determining, with the processor, that the second student requires instructional intervention; and
notifying, with the processor, a teacher that the student requires instructional intervention.

15. The method of claim 14, wherein determining that the second student requires instructional intervention comprises:
determining, with the processor, that the second answer is incorrect;
determining, with the processor, that the difficulty index is less than a baseline difficulty threshold;
incrementing, with the processor, a second remediation score associated with the second student;
determining that the second remediation score exceeds a remediation threshold value; and
determining, with the processor, that the student has already been assigned a remediation course for a topic related to the question.

16. The method of claim 14, further comprising:
analyzing, with the processor, a third answer of the answers provided by a third student of the students;
determining, with the processor, that the third answer is correct; and
incrementing, with the processor, a progress score of the third student.

17. The method of claim 12 further comprising:
determining, with the processor, that the first answer is incorrect;
determining, with the processor, that the difficulty index is greater than than a baseline difficulty threshold;
incrementing, with the processor, a difficulty score, wherein the question is part of an assessment, wherein the difficulty score is associated with the assessment;
determining, with the processor, that the difficulty score exceeds a predetermined threshold; and
providing, with the processor, a prompt to a teacher indicating that the topic should be re-taught.
